(19) United States
(12) Patent Application Publication
(10) Pub. No.: US 2008/0030170 A1
(43) Pub. Date: Feb. 7, 2008

(54) Safety charging system for surgical hand piece

(76) Inventors: Bruno Dacquay, Irvine, CA (US); Cesario P. Dos Santos, Aliso Viejo, CA (US); Casey J. Lind, Irvine, CA (US); Paul R. Hallen, Colleyville, TX (US)

Correspondence Address: ALCON, IP LEGAL, TB4-8, 6201 SOUTH FREEWAY, FORT WORTH, TX, 76134, US

(21) Appl. No.: 11/498,400

(22) Filed: Aug. 3, 2006

(51) Int. Cl. H02J 7/00; G06F 17/00; G08B 13/14

(52) U.S. Cl. 320/137; 340/572.8; 235/375

(57) ABSTRACT

A safety charging system for a battery-operated surgical hand includes a charging base, a battery pack, and control logic. The charging base has an RFID reader antenna disposed near a top surface of the charging base and charge circuitry for charging the battery. The battery pack has the battery used with the hand piece and an RFID tag antenna disposed near a bottom surface of the battery pack. The control logic determines if the battery should be charged based on a data point read by the RFID reader antenna.

### FIELD OF THE INVENTION

The present invention relates to a safe battery charging system for surgical hand pieces and more particularly to a battery charge limiting base for surgical hand pieces.

### BACKGROUND OF THE INVENTION

Many operations performed today involve the use of electrically-powered surgical tools. A surgical tool is usually in the form a hand piece that can be held and manipulated by a surgeon during an operation. Traditionally, each hand piece also has a cable that attaches to the main console of a surgical machine. In this manner, the main surgical console provides power to and controls the operation of the hand piece.

In ophthalmic surgery, for example, one hand piece is designed to allow a surgeon to perform a particular procedure, such as administering a drug to the posterior of the eye. The hand piece has a cable that provides electrical power to it. The cable attaches to a surgical console that is designed to perform many different procedures in an ophthalmic surgery. The surgeon uses the hand piece to deliver the necessary drug.

Instead of using a cable to power the hand piece, it would be desirable to have a hand piece that is battery-operated and more easily manipulated in the hand. Eliminating the cable attachment and incorporating battery power makes the hand piece more portable and less cumbersome to operate. A battery-operated hand piece can be recharged many times to perform the same procedure.

However, using battery power also raises a safety issue. A surgeon must be certain that enough power can be delivered by the battery to safely perform the procedure. In other words, the battery must be sufficiently charged to allow the procedure to be performed safely. This is especially true for high risk procedures that would harm the patient if they were interrupted. For example, if the battery in a battery-powered hand piece used to cauterize an incision is not sufficiently charged, then the use of that hand piece could harm the patient. If the hand piece ceases proper function during a cauterization procedure, then the patient could be susceptible to harmful bleeding.

Another example is the delivery of a drug to the posterior of the eye. If the battery in a battery-powered drug delivery device is not sufficiently charged and the device ceases to operate, the surgeon will have to withdraw the device and make a new insertion. Since drug delivery devices typically involve specialized needles that are inserted into the eye, the removal of one needle and the insertion of another needle can cause unnecessary trauma that could harm the patient.

It would be desirable to have a system for ensuring the safe operation of a battery-powered hand piece for use in medical procedures.

### SUMMARY OF THE INVENTION

In one embodiment consistent with the principles of the present invention, the present invention is a safety charging system for a battery-operated surgical hand piece. The safety charging system includes a charging base, a battery pack, and control logic. The charging base includes an RFID reader antenna disposed near a top surface of the charging base and charge circuitry for charging the battery. The battery pack includes the battery used with the hand piece and an RFID tag antenna disposed near a bottom surface of the battery pack. The control logic determines if the battery should be charged based on a data point read by the RFID reader antenna.

In another embodiment consistent with the principles of the present invention, the present invention is a method of safely operating a battery-operated surgical hand piece. The method includes recognizing a communications link between a charging base and a battery pack, reading a charge level from the battery pack, and, based on the charge level, determining if it is safe to use the battery pack for a medical procedure.

In another embodiment consistent with the principles of the present invention, the present invention is a method of safely operating a battery-operated surgical hand piece. The method includes recognizing a communications link between a charging base and a battery pack, reading a charge count from the battery pack, and, based on the charge count, determining if it is safe to use the battery pack for a medical procedure.

In another embodiment consistent with the principles of the present invention, the present invention is a method of safely operating a battery-operated surgical hand piece. The method includes recognizing a communications link between a charging base and a battery pack, reading a charge level from the battery pack, reading a charge count from the battery pack, and, based on the charge level and charge count, determining if it is safe to charge the battery pack for use in a medical procedure.

In another embodiment consistent with the principles of the present invention, the present invention is a method of safely operating a battery-operated surgical hand piece. The method includes recognizing a communications link between a charging base and a battery pack, reading a charge count from the battery pack, based on the charge count, determining a number of medical procedures that can safely be performed with the battery pack, and displaying the number of medical procedures that can safely be performed with the battery pack.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view of a charging base according to an embodiment of the present invention.

FIG. 2 is a perspective view of a battery-operated surgical hand piece according to an embodiment of the present invention.

FIG. 3 is an exploded cross section view of a charging base and battery pack according to an embodiment of the present invention.

FIG. 4 is a flow chart of one method of operation according to an embodiment of the present invention.

FIG. 5 is a flow chart of one method of operation according to an embodiment of the present invention.

FIG. 6 is a flow chart of one method of operation according to an embodiment of the present invention.

FIG. 7 is a flow chart of one method of operation according to an embodiment of the present invention.

FIG. 8 is a flow chart of one method of operation according to an embodiment of the present invention.

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers are used throughout the drawings to refer to the same or like parts.

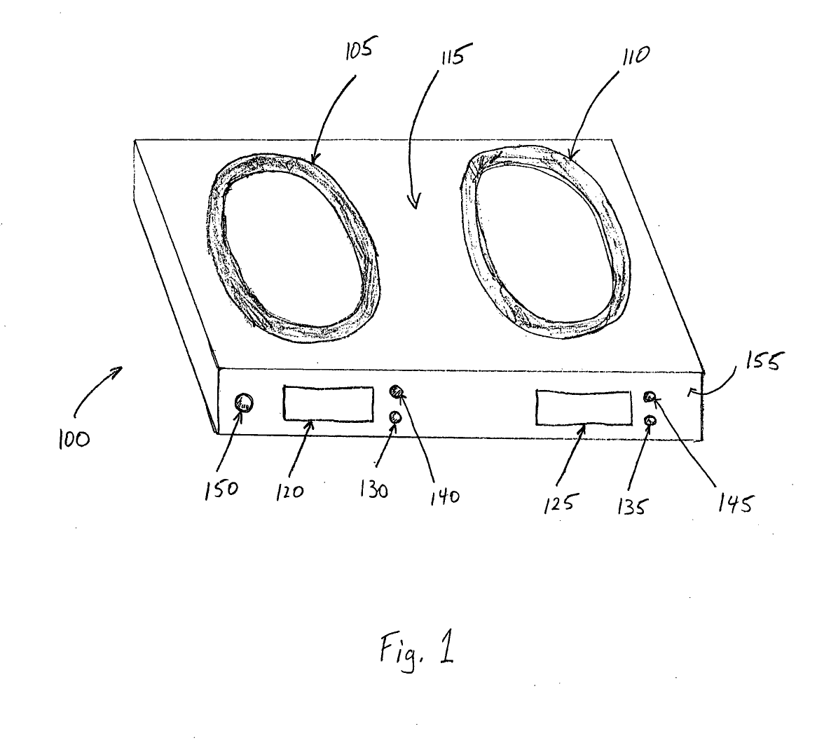

FIG. 1 is a perspective view of a charging base according to an embodiment of the present invention. Charging base 100 includes two holders 105, 110 disposed on its top surface 115. These holders 105, 110 are each designed to receive a battery pack (not shown). The battery packs (not shown) rest in holders 105, 110. Holders 105,110 are designed to locate the battery packs on the top surface 115 of charging base 100 to enable a communications link between the battery packs (not shown) and the charging base 100. Holders 105, 110 are also designed to locate the battery packs (not shown) on top surface 115 so that charging can take place.

Front surface 155 of charging base 100 has a power indicator 150, two displays 120, 125, two “charging” indicators 130, 135, and two “charge complete” indicators 140, 145. Power indicator 150 is a light emitting diode (LED) that is illuminated when the charging base is turned on or powered. “Charging” indicator 130 is associated with holder 105. “Charging” indicator 135 is associated with holder 110. When charging base 100 is charging a battery pack located in holder 105, “charging” indicator 130 is illuminated. Likewise, when charging base 100 is charging a battery pack located in holder 110, “charging” indicator 135 is illuminated. “Charging” indicators 130,135 can be implemented with LEDs.

“Charge complete” indicator 140 is associated with holder 105, and “charge complete” indicator 145 is associated with holder 110. When charging base 100 has finished charging a battery pack located in holder 105, “charge complete” indicator 140 is illuminated. Likewise, when charging base 100 has finished charging a battery pack located in holder 110, “charge complete” indicator 145 is illuminated. “Charging” indicators 140, 145 can be implemented with LEDs.

Display 120 is associated with holder 105, and display 125 is associated with holder 110. Display 120 provides information about the battery pack located in holder 105. Likewise, display 125 provides information about the battery pack located in holder 110. Displays 120, 125 can be any type of small display capable of displaying numbers. One such display is a simple seven segment liquid crystal display. In another embodiment, displays 120, 125 are capable of displaying letters in addition to numbers. In this manner, displays 120, 125 can provide information to a user of charging base 100.

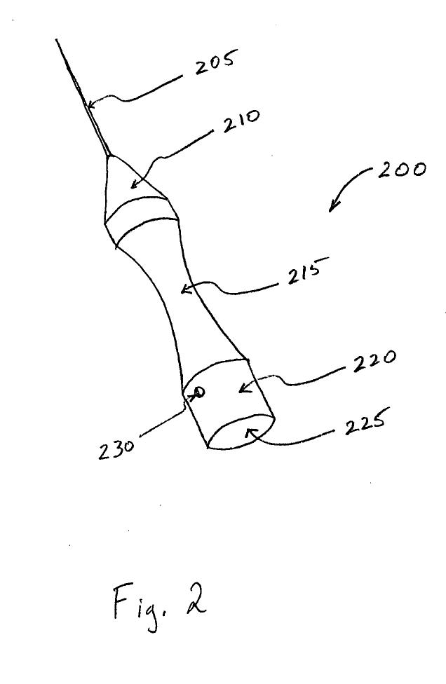

FIG. 2 is a perspective view of a battery-operated surgical hand piece according to an embodiment of the present invention. Hand piece 200 includes a working tip 205, top end 210, body 215, battery pack 220, and optional indicator 230. Working tip 205 is located at one end of the hand piece above top end 210. In one embodiment, working tip 205 is designed to be inserted into the eye during ophthalmic surgery. If hand piece 200 is a drug delivery device, then working tip 205 is a needle designed to administer a dosage of a drug to the eye. Body 215 is designed to be held in the hand by a surgeon.

Battery pack 220 is located on the end of hand piece 200 opposite the working tip 205. Battery pack 220 may be integrated into hand piece 200, or it may be removable from body 215. If removable, battery pack 220 is designed to power numerous different hand pieces. In this manner, battery pack 220 is a universal battery pack for use with several different battery-powered hand pieces. In such a case, battery pack 220 has electrical and mechanical connectors (not shown) to couple the battery pack to hand piece body 215. Likewise, body 215 has electrical and mechanical connectors (not shown) designed to couple with the connectors on battery pack 220. The same connectors found on body 215 are also found on other hand pieces designed to operate with battery pack 220. In this system, a single battery pack can be used with different hand pieces. If the battery pack 220 is no longer operable, then a new battery pack can be coupled to the hand piece body 215. Since batteries have limited lives, and in general, lives much shorter than the hand piece body itself, a system that uses a universal battery pack allows the hand piece body 215 to be used for longer periods of time. In addition, it is easy to change the battery pack 220 if it is of a universal type described herein.

In the same manner, working tip 205 and top end 210 may be removable from the body 215 of hand piece 200. Different working tips and top ends may be used with body 215. In such a case, the hand piece body 215 is a universal body for use with different working tips.

Indicator 230 is optional. In this embodiment, indicator 230 is an LED that illuminates when the battery pack needs to be replaced. When the battery pack 220 is no longer able to be safely charged, indicator 230 is illuminated and battery pack 230 is disabled. Bottom surface 225 is designed to rest in holder 105 or holder 110 located on top surface 115 of the charging base 100 of FIG. 1.

Hand piece 200 may be any type of electrically-powered surgical or medical tool. For example, hand piece 200 may be an illuminator, laser, cauterizing device, or a drug delivery device. In one embodiment, hand piece 200 is a device for injecting a drug into the posterior of an eye. The hand piece 200 contains a drive mechanism and heater that can be powered by a battery. The heater warms the drug to the proper temperature and the drive mechanism operates a plunger that delivers the drug through a needle and into the eye.

Hand piece 200 may contain control circuitry (not shown) or it may be controlled via a wireless connection to a surgical console. In one embodiment, hand piece 200 contains simple integrated circuits that can control the various functions performed by hand piece 200. For example, hand piece 200 may contain a simple circuit that controls the operation of a heater coil or a motor. Eliminating a wired connection to a main surgical console and putting all of the control circuitry and battery power in the hand piece makes for a more mobile and easy to use device.

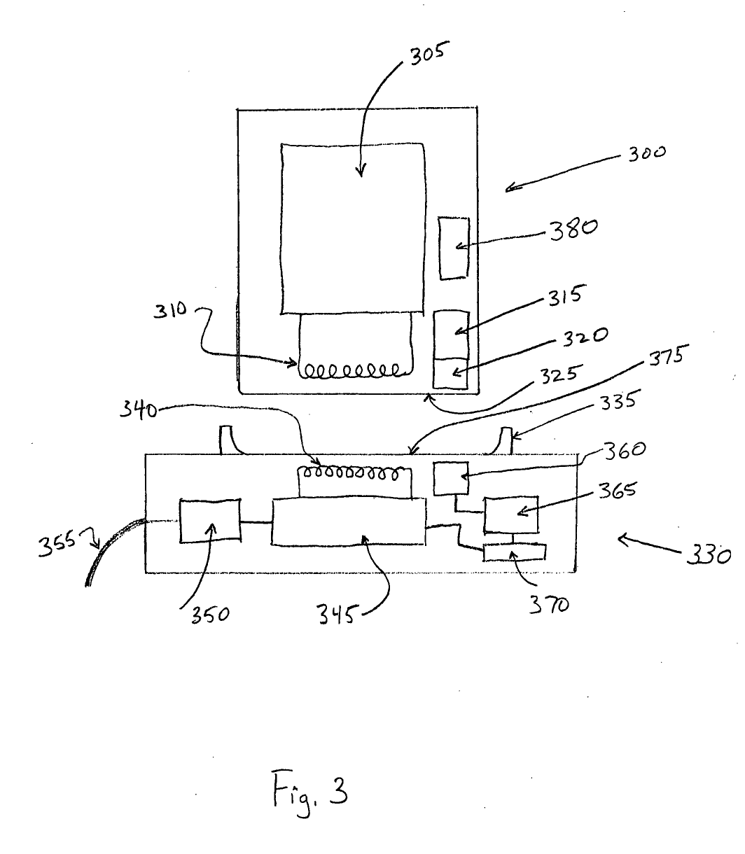

FIG. 3 is an exploded cross section view of a charging base and battery pack according to an embodiment of the present invention. In FIG. 3, battery pack 300 is designed to rest on charging base 330. Battery pack 300 includes battery 305, secondary coil 310, RFID tag integrated circuit 315, RFID tag antenna 320, and battery charge control circuitry 380. Charging base 330 includes circular holder rim 335, primary coil 340, base charge control circuitry 345, power conditioning circuitry 350, power line 355, RFID reader antenna 360, RFID reader circuitry 365, and control logic 370.

Battery pack 300 is in the shape of a cylinder. As described with reference to FIG. 2, battery pack 300 may be a universal battery pack that is removable from the hand piece. In this manner, the battery pack itself can be removed from the hand piece so that it can be charged. When the bottom surface 325 of battery pack 300 is resting on the top surface 375 of charging base 330, the battery pack is engaged in circular holder rim 335. In this position, the RFID reader antenna 360 is located close to the RFID tag antenna 320 enabling a communications link to be established.

In this manner, an RFID system allows the transfer of information, such as a charge count and a charge level, to take place between battery pack 300 and charging base 330. Battery pack 300 has an RFID tag which includes an RFID tag integrated circuit (IC) 315 and an RFID tag antenna 320. RFID tag IC 315 typically includes memory in which information, such as a charge count, can be stored. In addition, RFID tag IC 315 may store other information such as a product identifier. RFID tag antenna may be located anywhere near bottom surface 320 of battery pack 300. In order to improve the read and write capabilities of the RFID system, it is desirable to locate RFID tag antenna 315 at a location near the bottom surface 325 of battery pack 300 so that when the battery pack 300 is resting on top surface 375 of charging base 330, RFID tag antenna 315 is close to RFID reader antenna 360.

The RFID reader portion of the RFID system is contained in charging base 330. RFID reader antenna 360 is located close to the top surface 375 of charging base 330. RFID reader circuitry 365 is also located in charging base 330. RFID reader circuitry 365 is designed to read information from the RFID tag.

In one type of RFID system, a passive RFID system, the RFID tag does not have an internal power supply. Instead, the passive RFID tag relies on the electromagnetic field produced by the RFID reader circuitry 365 for its power. The electromagnetic field produced by the RFID reader circuitry 365 and emitted from the RFID reader antenna 360 induces an small electircal current in the RFID tag antenna 320. This small electircal current allows the RFID tag IC 315 to operate. In this passive system, the RFID tag antenna 320 is designed to both collect power from the electromagentic field produced by the RFID reader circuitry 365 and emitted by the RFID reader antenna 360 and to transmit an outbound signal that is received by the RFID reader antenna 360.

In operation, the RFID reader antenna 360 transmits a signal produced by the RFID reader circuitry 365. The RFID tag antenna 320 receives this signal and a small current is induced in the RFID tag antenna 320. This small current powers RFID tag IC 315. RFID tag IC 315 can then transmit a signal through RFID tag antenna 320 to RFID reader antenna 360 and RFID reader circuitry 365. In this manner, the RFID tag and the RFID reader can communicate with each other over a radio frequency link. RFID tag IC 315 transmits information, such as the charge count or the charge level of the battery 305, through RFID tag antenna 320 to the RFID reader. This information is received by RFID reader antenna 360 and RFID reader circuitry 365. In this manner, information can be transferred from the battery pack 300 to the charging base 330.

The RFID reader can transmit information to the RFID tag in a similar fashion. For example, RFID reader circuitry 365 can transmit a new charge count over the radio frequency signal emitted by RFID reader antenna 360. RFID tag antenna 320 receives this radio frequency signal with the new charge count. RFID tag IC 315 can then store the new charge count in its memory. In addition, the RFID system need not be passive. The RFID tag may be powered by battery 305.

While the present invention is described as having an RFID system, any other type of wireless system can be used to transfer information between the battery pack 300 and the charging base 330. For example, a Bluetooth protocol may be used to establish a communications link between the battery pack and the charging base. Information can then be transferred between the battery pack 300 and the charging base 330 over this communications link. If the system utilizes a Bluetooth protocol, then blocks 315, 320, 360, and 365 contain the circuitry for Bluetooth communications. Other embodiments used to transfer information include an infrared protocol, 802.11, firewire, or other wireless protocol. Likewise, blocks 315, 320, 360, and 365 contain the circuitry for these other types of communications.

When the bottom surface 325 of battery pack 300 is resting on the top surface 375 of charging base 330, the battery pack is engaged in circular holder rim 335. In this position, as noted, the RFID reader antenna 360 is located close to the RFID tag antenna 320 enabling a communications link to be established. In addition, primary coil 340 is aligned with secondary coil 310 to allow charging to take place.

In the embodiment shown in FIG. 3, an inductive charging circuit is shown. Inductive charging utilizes a transformer that is essentially split into two parts. The primary coil 340 of the transformer is located in the charging base 330 close to its top surface 375. The secondary coil of the transformer 310 is located in the battery pack 300 close to its bottom surface 325. When the charging base is connected to AC power through power line 355, the primary coil 340 is energized. When the secondary coil 310 is placed on the top surface 375 of the charging base 330, a current is induced in the secondary coil 310. This current charges battery 305.

Other elements of the charging circuit include power conditioning circuitry 350, base charge control circuitry 345, and battery charge control circuitry 380. Power conditioning circuitry 350 may have elements for surge protection and filtering. Base charge control circuitry 345 and battery charge control circuitry 380 control the charging method used to charge battery 305. As is known, different charging algorithms are suitable for different types of batteries. If battery 305 is a lithium ion battery, then an algorithm that ensures that the battery 305 is not over charged or subject to an over voltage condition is appropriate. In other words, for a lithium ion battery, a voltage limit algorithm is appropriate.

While described as a lithium ion battery, it is understood that battery 305 may be any type of rechargeable battery. An appropriate and well-known charging algorithm can be used with the type of battery selected.

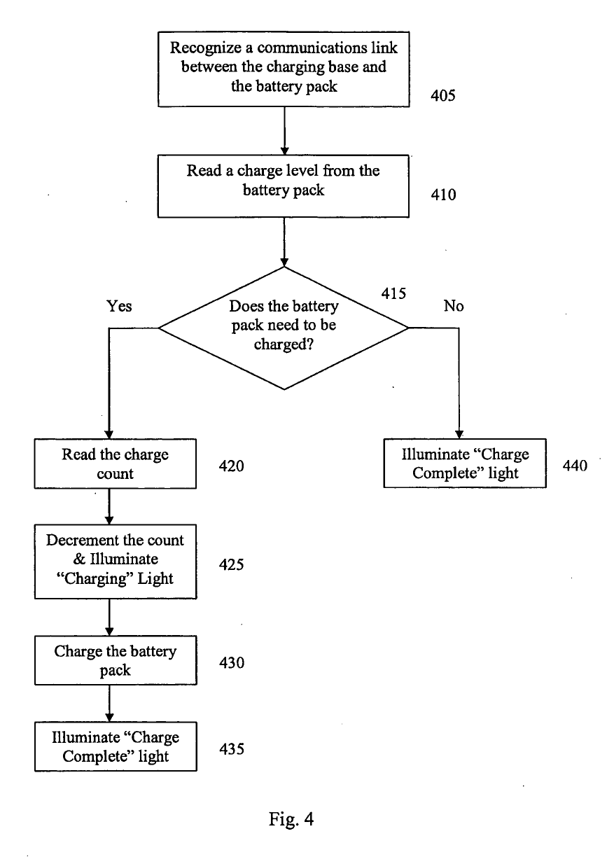

Charging base 330 also contains control logic 370. Control logic 370 is designed to implement the various safety algorithms described in more detail in FIGS. 4-8. In operation, control logic 370 activates various indicators on the front surface 155 of charging base 100. Control logic 370 also turns the charging process on and off and controls the reading and writing of information, such as a charge count, between the battery pack 300 and the charging base 330.

An example of the operation of the battery pack and charging base is depicted in FIGS. 4-8. FIG. 4 is a flow chart of one safety operation performed by the charging base and battery pack. In 405, a communications link between the battery pack and the charging base is recognized. This occurs when the battery pack is placed on the charging base. The communications link is established via the RFID system described above. In 410, the charging base reads a charge level from the battery pack. The charge level is indicative of the amount of charge that the battery contains. For example, if the battery is half-charged, then the charge level is 50%.

In 415, the control logic determines if the battery pack needs to be charged. If it does not need to be charged, then in 440, the control logic illuminates the “charge complete” light indicating that the battery pack is ready to be used. If the battery pack needs to be charged, then in 420, the charging base, through the RFID reader antenna 360 and RFID reader circuitry, reads the charge count from the battery pack. As noted, the charge count is stored in memory located on or associated with the RFID tag IC 315. In 425, the control logic decrements the charge count and illuminates the “charging” light indicating that the battery pack is in the process of being charged. After the charge count is decremented, it is transmitted to the RFID tag by the RFID reader. The decremented charge count is stored in memory located on or associated with the RFID tag IC 315. In 430, the battery pack is charged. After the battery pack is charged, in 435, the “charge complete” light is illuminated indicating that the battery pack is ready to be used. When the battery pack is removed from the charging base, the RFID communications link is broken and the “charge complete” light is turned off. In this manner, the RFID communications link is used to establish the presence or absence of a battery pack on a charging base.

In FIG. 4, the control logic determines if the battery pack needs to be charged by comparing the charge level read from the battery pack with a threshold charge level. Most hand pieces can perform several procedures on a single charge. Therefore, it is not necessary to fully charge the battery before each procedure. For example, one fully charged battery pack may be able to power a hand piece for eight procedures. In such a case, each procedure consumes approximately 12.5% of the battery charge. The threshold charge level may be set at 25%. This ensures that the charge remaining on the battery is twice that needed to perform a procedure safely. In other words, the hand piece can be used six times without charging. After the sixth use, if the charge level is below 25%, then the battery pack is fully charged. If it is not below 25%, then it is not. In either case, the control logic ensures that more than sufficient battery life exists to safely perform the next procedure.

The threshold value can be set differently for different hand pieces. Since each hand piece is designed to perform a different procedure and since different procedures require different levels of power, the threshold is dependent upon the type of hand piece used and the type of procedure performed. Alternatively, a single high threshold can be set to ensure that the battery pack has sufficient power for any procedure. This may be beneficial for a battery pack that is used with numerous different hand pieces. In such a case, a universal battery pack may provide power to different hand pieces with different power requirements.

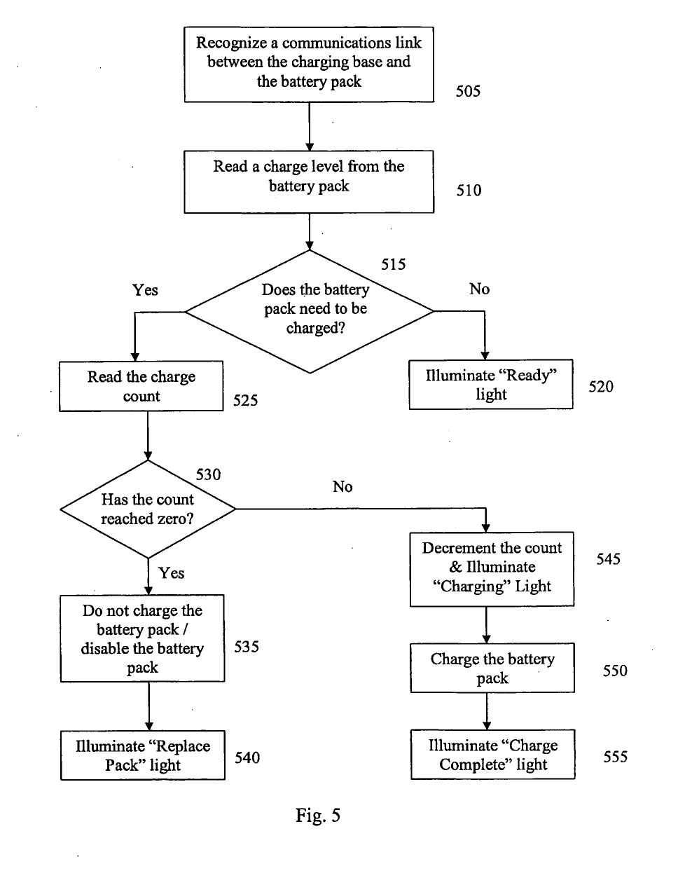

FIG. 5 is a flow chart showing another mode of operation of the safety charging system of the present invention. In 505, a communications link is recognized between the battery pack and the charging base. As noted before, this communications link is established by the RFID system. In 510, the charge level is read from the battery pack. In 515, the control logic determines if the battery pack needs to be charged. If it does not need to be charged, that is, if the charge level read from the battery pack is above the threshold, then in 520, the “ready” or “charge complete” light is illuminated. The battery pack is not charged. Instead, the control logic determined that the charge level, indicating the charge remaining on the battery, is sufficient to safely perform a procedure. When the battery pack is removed, the RFID link is broken and the control logic then knows that the battery pack has been removed.

If the battery pack needs to be charged, then in 525, the RFID reader reads the charge count from the RFID tag. In 530, the control logic determines if the charge count has reached zero. If the charge count has reached zero, then in 535, the charging base does not charge the battery pack. Alternatively, the battery pack is disabled. In 540, the “replace pack” light is illuminated. This light can be located on the charging base or on the battery pack itself.

In 530, if the control logic determines that the charge count has not reached zero, then in 545, the control logic decrements the charge count by one and illuminates the “charging” light. The decremented charge count is written to the RFID tag. In 550, the charging base charges the battery pack. In 555, after the battery pack is fully charged, the “charge complete” light is illuminated.

In FIG. 5, the charge count plays a role in the safety procedure. Typically, a battery pack is limited to between 600 and 1000 charges. That is, the same battery pack can be recharged only 600 to 1000 times. Beyond this number, the battery pack may not be able to properly hold a charge. Also, the battery pack is more susceptible to failure. An initial charge count can be established. For example, the charge count may be established at 700. The number 700 is stored on the RFID tag. Each time the battery pack is charged, the charge count is decremented by one. So, the first time it is charged, the count becomes 699. This counter, implemented in a charge count number, tracks the number of times a battery pack is charged. When the charge count reaches zero, the battery pack is no longer allowed to be charged. The battery pack can be disabled using any number of known techniques.

The initial charge count is based on the type of battery used in the battery pack. Certain batteries can be recharged a greater number of times. Other batteries cannot. In addition, some batteries, like lithium ion batteries, have a certain shelf life. All of these factors can be used to determine the initial charge count.

While the charge count is described as being decremented, it is understood that it can also be incremented. In this case, the charge count could start at zero. Each time the battery pack is charged, the charge count is increased by one. When the charge count reaches the threshold number, it is disabled or it is no longer charged.

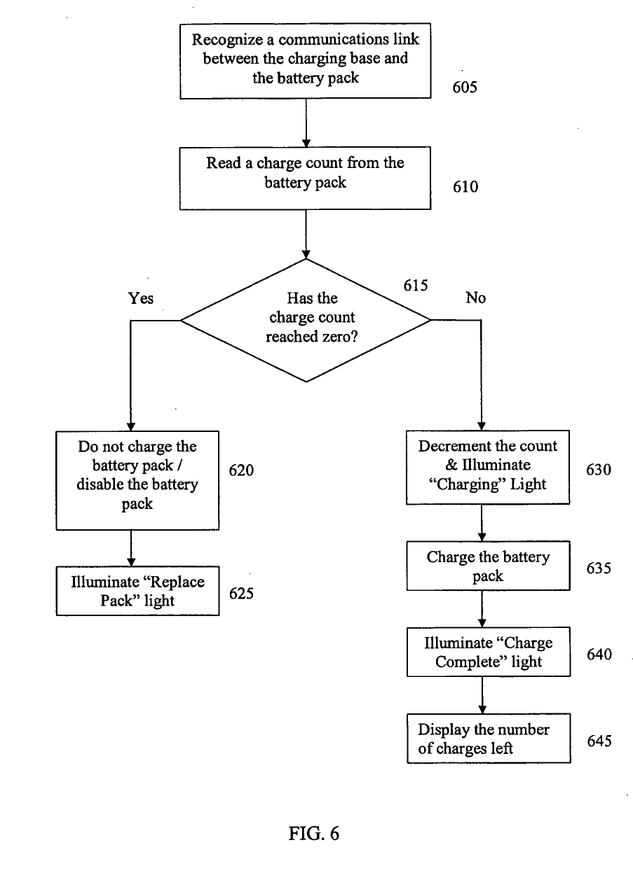

FIG. 6 is a flow chart showing another mode of operation of the safety charging system of the present invention. In 605, a communications link is recognized between the battery pack and the charging base. As noted before, this communications link is established by the RFID system. In 610, the charge count is read from the battery pack. In 615, the control logic determines if the charge count has reached zero. If it has, then in 620, the charging base does not charge the battery pack and/or disables it. In 625, the “replace pack” indicator is illuminated. In 615, if the control logic determines that the charge count has not reached zero, then in 630, the control logic decrements the charge count by one and illuminates the “charging” light. The decremented charge count is written to the RFID tag. In 635, the charging base charges the battery pack. In 640, after the battery pack is fully charged, the “charge complete” light is illuminated. In 645, the number of charges remaining is displayed on the display.

In FIG. 6, the number of charges remaining can be displayed to give the doctor an indication of when to order a new battery pack. In this manner, the charge count itself is displayed. The charge count indicates the number of times that the battery pack can be recharged and therefore gives useful information about its remaining life. Other useful information, such as the charge level, may also be displayed as well.

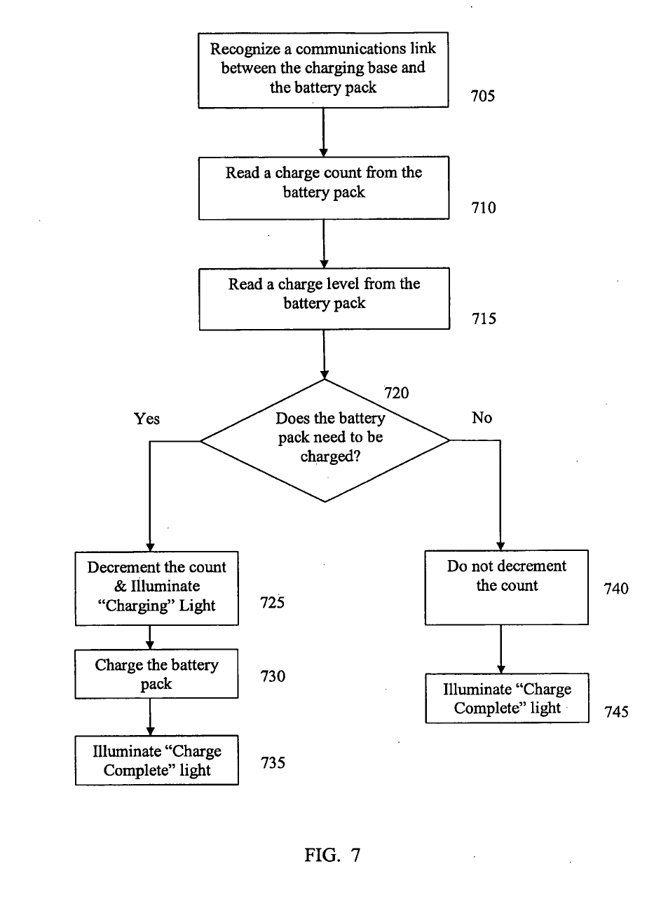

FIG. 7 is a flow chart showing another mode of operation of the safety charging system of the present invention. In 705, a communications link is recognized between the battery pack and the charging base. As noted before, this communications link is established by the RFID system. In 710, the charge count is read from the battery pack. In 715, the charge level is read from the battery pack. In 720, the control logic determines if the battery needs to be recharged. Also, the control logic can determine if the battery pack should be charged or if it can no longer be safely used.

If the battery pack needs to be charged, then in 725, the control logic decrements the charge count by one and illuminates the “charging” light. The decremented charge count is written to the RFID tag. In 730, the charging base charges the battery pack. In 735, after the battery pack is fully charged, the “charge complete” light is illuminated.

If the battery pack does not need to be charged, then in 740, the count is not decremented. In 745, the “charge complete” light is illuminating indicating that the battery pack is ready to be used. In this case, there was sufficient charge left on the battery and the battery pack was not charged.

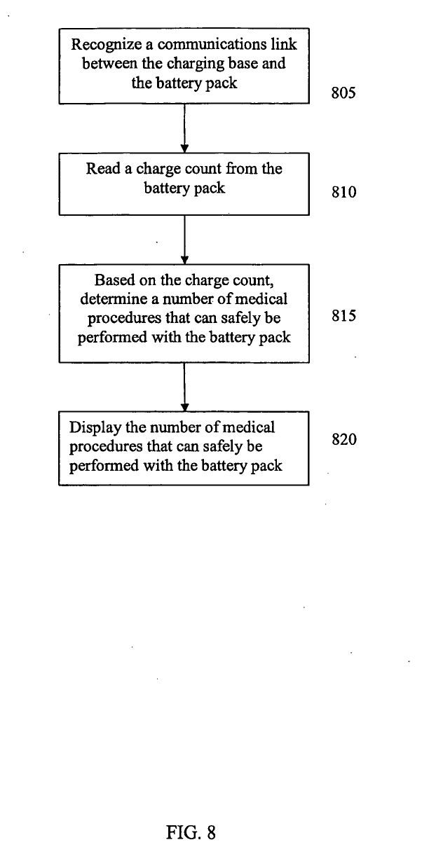

FIG. 8 is a flow chart showing another mode of operation of the safety charging system of the present invention. In 805, a communications link is recognized between the battery pack and the charging base. As noted before, this communications link is established by the RFID system. In 810, the charge count is read from the battery pack. In 815, the control logic determines the number of medical procedures that can safely be performed with the battery pack. In 820, that number is displayed on the display. In this manner, useful information, like the number of procedures remaining, the charge level, or the charge count can be displayed.

The control logic can determine the number of procedures that can be performed by a battery pack as described above. If a fully charged battery can perform eight procedures, then the next time the battery pack is inserted in the charging base, the number displayed is seven. Alternatively, the charge level can be read and divided by the amount of charge needed to perform a procedure. The result can then be displayed. For example, if a procedure can be performed with 10% of the charge contained in a fully charged battery, then if the battery is 70% charged, seven procedures can be performed. This number can be decreased by one to ensure that a safety margin is maintained. In such a case, a battery pack with a 70% charge can perform six procedures safely. The number 6 is displayed on the display.

From the above, it may be appreciated that the present invention provides an improved system and methods for safely operating battery-powered surgical hand pieces. The present invention prevents unwanted battery failure by ensuring that a battery pack is properly charged for a given procedure. The present invention is illustrated herein by example, and various modifications may be made by a person of ordinary skill in the art.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A safety charging system for a battery-operated surgical hand piece comprising:
a charging base for charging a battery used with the hand piece, the charging base comprising an RFID reader antenna disposed near a top surface of the charging base and charge circuitry for charging the battery;
a battery pack comprising the battery used with the hand piece and an RFID tag antenna disposed near a bottom surface of the battery pack; and
control logic for determining if the battery should be charged based on a data point read by the RFID reader antenna.

2. The system of claim 1 wherein the data point is a charge count for the battery.

3. The system of claim 1 wherein the data point is a charge level of the battery.

4. The system of claim 1 further comprising a display for showing the number of charge cycles remaining for the battery pack.

5. The system of claim 1 further comprising a display for showing the number of charge cycles that the battery pack has undergone.

6. The system of claim 1 further comprising an indicator.

7. The system of claim 1 wherein the charging base further comprises a primary coil and the battery pack further comprises a secondary coil.

8. The system of claim 1 wherein the charging base further comprises RFID reader circuitry and the battery pack further comprises an RFID tag integrated circuit.

9. The system of claim 1 further comprising circuitry for disabling the battery pack when the control logic determines that the battery pack is unsafe.

10. The system of claim 1 further comprising power conditioning circuitry.

11. A method of safely operating a battery-operated surgical hand piece comprising:
recognizing a communications link between a charging base and a battery pack;
reading a charge level from the battery pack; and
based on the charge level, determining if it is safe to use the battery pack for a medical procedure.

12. The method of claim 11 further comprising:
charging the battery pack if it is not safe to use the battery pack for the medical procedure.

13. The method of claim 12 further comprising:
reading a charge count from the battery pack; and
decrementing the charge count by one.

14. The method of claim 12 further comprising:
reading a charge count from the battery pack; and
incrementing the charge count by one.

15. The method of claim 11 further comprising:
illuminating a light if it is safe to use the battery pack for a medical procedure.

16. A method of safely operating a battery-operated surgical hand piece comprising:
recognizing a communications link between a charging base and a battery pack;
reading a charge count from the battery pack; and
based on the charge count, determining if it is safe to use the battery pack for a medical procedure.

17. The method of claim 16 further comprising:
disabling the battery pack if it is not safe to use the battery pack for the medical procedure.

18. The method of claim 16 further comprising:
charging the battery pack if it is safe to use the battery pack for the medical procedure; and
decrementing the charge count by one.

19. A method of safely operating a battery-operated surgical hand piece comprising:
recognizing a communications link between a charging base and a battery pack;
reading a charge level from the battery pack;
reading a charge count from the battery pack; and
based on the charge level and charge count, determining if it is safe to charge the battery pack for use in a medical procedure.

20. The method of claim 19 further comprising:
charging the battery pack if it is safe to use the battery pack in the medical procedure; and
decrementing the charge count by one.

21. A method of safely operating a battery-operated surgical hand piece comprising:
recognizing a communications link between a charging base and a battery pack;
reading a charge count from the battery pack;
based on the charge count, determining a number of medical procedures that can safely be performed with the battery pack; and
displaying the number of medical procedures that can safely be performed with the battery pack.

22. A safety charging system for a battery-operated surgical hand piece comprising:
a charging base for charging a battery used with the hand piece, the charging base comprising a first circuit for communicating with the hand piece and charge circuitry for charging the battery;
a battery pack comprising the battery used with the hand piece and a second circuit for communicating with the charging base; and
control logic for determining if the battery should be charged based on a data point received by the first circuit.

23. The system of claim 22 wherein the data point is a charge count for the battery.

24. The system of claim 22 wherein the data point is a charge level of the battery.

25. The system of claim 22 further comprising a display for showing the number of charge cycles remaining for the battery pack.

26. The system of claim 22 further comprising an indicator.

27. The system of claim 22 wherein the charging base further comprises a primary coil and the battery pack further comprises a secondary coil.

28. The system of claim 22 further comprising circuitry for disabling the battery pack when the control logic determines that the battery pack is unsafe.

29. The system of claim 22 further comprising power conditioning circuitry.
